(19) United States
(12) Patent Application Publication
(10) Pub. No.: US 2025/0014540 A1
(43) Pub. Date: Jan. 9, 2025

(54) MUSICAL SCORE EDITING DEVICE, MUSICAL SCORE EDITING METHOD, AND NON-TRANSITORY COMPUTER-READABLE STORAGE MEDIUM

(71) Applicant: YAMAHA CORPORATION, Hamamatsu-shi (JP)

(72) Inventor: Norihiro UEMURA, Hamamatsu-shi (JP)

(21) Appl. No.: 18/887,557

(22) Filed: Sep. 17, 2024

Related U.S. Application Data
(63) Continuation of application No. PCT/JP2023/007789, filed on Mar. 2, 2023.

(30) Foreign Application Priority Data
Mar. 18, 2022 (JP) 2022-044477

(51) Int. Cl. G10G 1/04; G06V 30/304

(52) U.S. Cl. CPC G10G 1/04; G06V 30/304

(57) ABSTRACT

A musical score editing device includes a processor that implements instructions to execute tasks. The tasks include: an image recognition task that recognizes an image of a musical score as first image data; a pitch reception task that receives designation of a pitch amount indicating a difference between keys before and after transposition; a musical note recognition task that recognizes one or more musical notes in the first image data; a musical note deletion task that outputs second image data obtained by deleting the musical notes from the first image data; a musical note transposition task that outputs third image data indicating an image of one or more musical notes after the transposition based on the pitch amount; and a synthesis task that synthesizes the second image data and the third image data to output fourth image data indicating an image of a musical score after the transposition.

### CROSS-REFERENCE TO RELATED APPLICATIONS

This is a continuation of International Application No. PCT/JP2023/007789 filed on Mar. 2, 2023, and claims priority from Japanese Patent Application No. 2022-044477 filed on Mar. 18, 2022, the entire content of which is incorporated herein by reference.

### FIELD

The present disclosure relates to a musical score editing device, a musical score editing method, and a non-transitory computer-readable storage medium for editing a musical score.

### BACKGROUND

As a technique for recognizing a musical score in an image format, JP2009-098161A describes a musical score recognition device in which a part template corresponding to a musical score read by a scanner is selected from a plurality of part templates stored in advance. The selected part template is used to automatically correct the musical score read by the scanner.

### SUMMARY

According to the musical score recognition device described in JP2009-098161A, in a case where the musical score read by the scanner is a musical score affecting a transposing musical instrument, it is possible to correct a key signature. However, in the technique described in JP2009-098161A, it is difficult to generate a transposed musical score.

An object of the present disclosure is to provide a musical score editing device, a musical score editing, and a non-transitory computer-readable storage medium capable of generating a transposed musical score.

A musical score editing device according to an aspect of the present disclosure includes: a memory storing computer-executable instructions; and a processor that implements the computer-executable instructions stored in the memory to execute a plurality of tasks, including: an image recognition task that recognizes an image of a musical score before transposition as first image data; a pitch reception task that receives designation of a pitch amount indicating a difference between a key before the transposition and a key after the transposition; a musical note recognition task that recognizes one or more musical notes in the first image data; a musical note deletion task that outputs second image data obtained by deleting the one or more musical notes from the first image data; a musical note transposition task that outputs third image data indicating an image of one or more musical notes after the transposition based on the pitch amount designated by the pitch reception task; and a synthesis task that synthesizes the second image data and the third image data to output fourth image data indicating an image of a musical score after the transposition.

According to the present disclosure, it is possible to generate a transposed musical score.

### BRIEF DESCRIPTION OF DRAWINGS

The present disclosure will be described in detail based on the following without being limited thereto, wherein:

FIG. 1 is a block diagram showing a configuration of a processing system including a musical score editing device according to an embodiment of the present disclosure;

FIG. 2 is a block diagram showing a configuration of the musical score editing device;

FIG. 3 is a diagram showing an example of an image of a musical score that is based on first image data recognized by an image recognition unit;

FIG. 4 is a diagram showing an example of an image of musical score elements that is based on image data generated from first text data;

FIG. 5 is a diagram showing an example of an image of a musical score that is based on second image data;

FIG. 6 is a diagram showing an example of an image of musical score elements after transposition that is based on third image data;

FIG. 7 is a diagram showing an example of an image of a musical score after transposition that is based on fourth image data;

FIG. 8 is a partially enlarged diagram showing an example of an image of a musical score after transposition in a first modification;

FIG. 9 is a partially enlarged diagram showing an example of an image of a musical score after transposition in a second modification;

FIG. 10 is a partially enlarged diagram showing an example of an image of a musical score after transposition in a third modification;

FIG. 11 is a diagram illustrating a fourth modification;

FIG. 12 is a diagram showing an example of an image of a musical score after transposition in the fourth modification;

FIGS. 13A and 13B are partially enlarged diagrams showing an example of images of the musical score before and after transposition in the fourth modification;

FIG. 14 is a partially enlarged diagram showing an example of an image of a musical score after transposition in a fifth modification;

FIG. 15 is a partially enlarged diagram showing an example of an image of a musical score after transposition in a sixth modification; and

FIG. 16 is a flowchart showing an example of musical score editing processing performed by the musical score editing device of FIG. 2.

### DETAILED DESCRIPTION

### (1) Configuration of Processing System

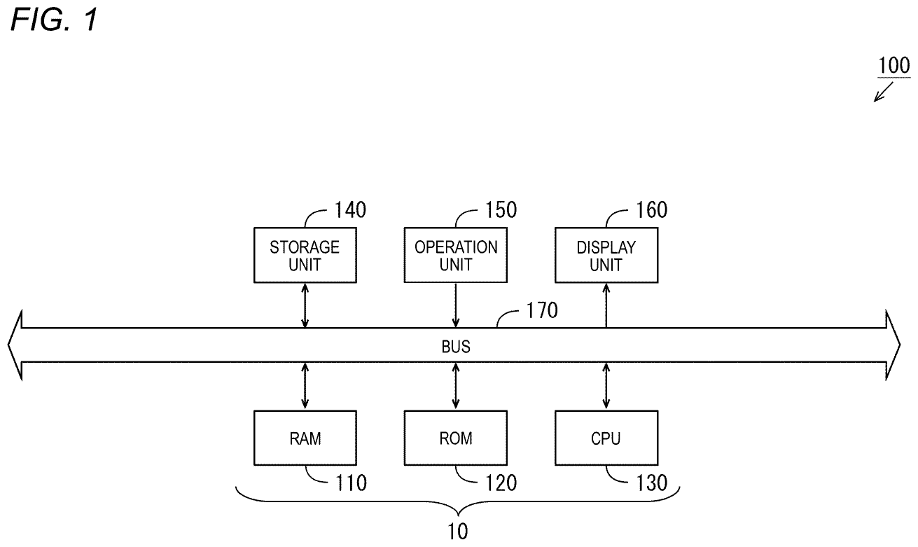

Hereinafter, a musical score editing device according to an embodiment of the present disclosure will be described in detail with reference to the drawings. FIG. 1 is a block diagram showing a configuration of a processing system including the musical score editing device according to the embodiment of the present disclosure. As shown in FIG. 1, a processing system 100 includes a random access memory (RAM) 110, a read only memory (ROM) 120, a central processing unit (CPU) 130, a storage unit 140, an operation unit 150, and a display unit 160.

The processing system 100 is implemented by a computer such as a personal computer, a tablet terminal, a smartphone, or a smart glass. Alternatively, the processing system 100 may be implemented by a cooperative operation of a plurality of computers connected to a communication path such as the Ethernet, or may be implemented by an electronic musical instrument having a performance function such as an electronic piano.

The RAM 110, the ROM 120, the CPU 130, the storage unit 140, the operation unit 150, and the display unit 160 are connected to a bus 170. The RAM 110, the ROM 120, and the CPU 130 constitute the musical score editing device 10.

The RAM 110 includes, for example, a volatile memory, and is used as a work area of the CPU 130. The ROM 120 includes, for example, a nonvolatile memory, and stores a musical score editing program. The CPU 130 performs musical score editing processing by executing the musical score editing program stored in the ROM 120 on the RAM 110. Details of the musical score editing processing will be described later.

The musical score editing program may be stored in the storage unit 140 instead of the ROM 120. Alternatively, the musical score editing program may be provided in a form of being stored in a computer-readable storage medium and installed in the ROM 120 or the storage unit 140. Alternatively, when the processing system 100 is connected to a network such as the Internet, the musical score editing program distributed from a server (including a cloud server) on the network may be installed in the ROM 120 or the storage unit 140.

The storage unit 140 includes a storage medium such as a hard disk, an optical disk, a magnetic disk, or a memory card. In the storage unit 140, a template (including a notation font for musical score drawing) for specifying various musical symbols included in image data indicating an image of a musical score (so-called static musical score) or a weighting parameter of a learning model used in deep learning or the like is stored in advance.

The operation unit 150 includes a pointing device such as a mouse or a keyboard, and is operated by a user to perform predetermined designation on the musical score editing device 10. The display unit 160 includes, for example, a liquid crystal display, and displays a result of the musical score editing processing performed by the musical score editing device 10. The operation unit 150 and the display unit 160 may be implemented by a touch panel display.

### (2) Configuration of Musical Score Editing Device

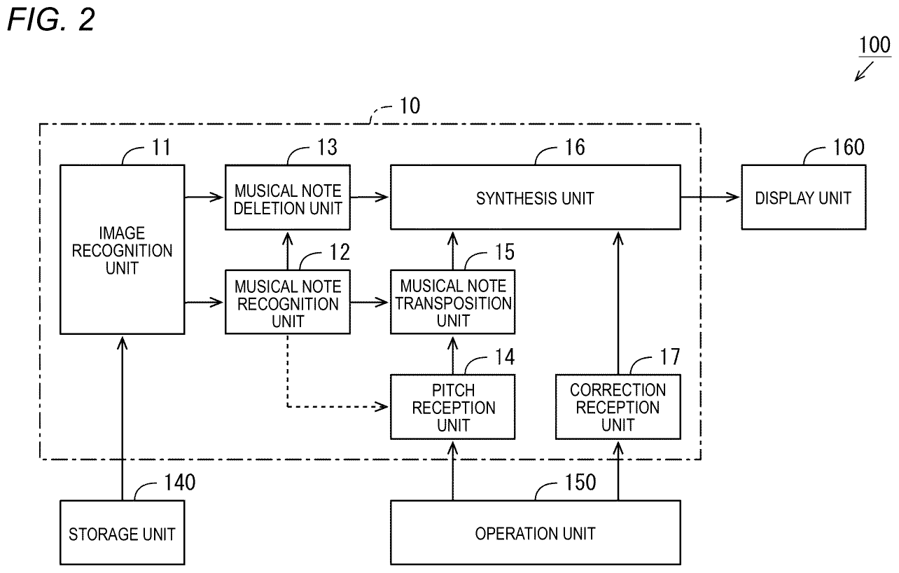

FIG. 2 is a block diagram showing a configuration of the musical score editing device 10. As shown in FIG. 2, the musical score editing device 10 includes, as functional units thereof, an image recognition unit 11, a musical note recognition unit 12, a musical note deletion unit 13, a pitch reception unit 14, a musical note transposition unit 15, a synthesis unit 16, and a correction reception unit 17. The functional units of the musical score editing device 10 are implemented when the CPU 130 of FIG. 1 executes the musical score editing program. At least a part of the functional units of the musical score editing device 10 may be implemented by hardware such as an electronic circuit.

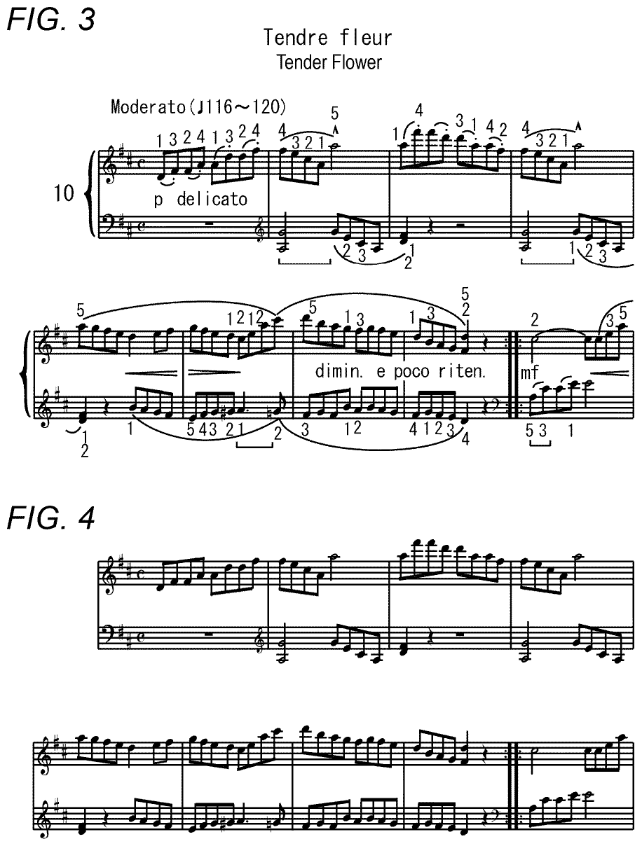

The image recognition unit 11 recognizes first image data indicating an image of a musical score by specifying various musical symbols in a given image of the musical score based on a template or a deep learning-based weight learning model, or the like stored in the storage unit 140. FIG. 3 is a diagram showing an example of the image of the musical score that is based on the first image data recognized by the image recognition unit 11.

In this example, only the musical symbols related to transposition need to be recognized. For example, a musical symbol that is not related to the transposition such as a bar line or a repetition symbol may not be recognized. Meanwhile, by recognizing a musical symbol that is not related to the transposition and performing drawing of FIG. 3, a musical score with a clear line can be generated even when a part of the line overlapping another symbol is deleted by the musical note deletion unit 13 to be described later. Since it is difficult to recognize and redraw a distorted line, a symbol to be recognized and a symbol to be deleted may be determined in consideration of a performance of the recognition function or a quality of the musical score to be processed.

The user can provide a desired image of the musical score before transposition to the image recognition unit 11. The image of the musical score before transposition may be an image in AR (augmented reality) visible through a smart device, smart glass, or the like. The same applies to an image of the musical score after transposition. In the example of FIG. 3, a musical score of Burgmuller 25 Etudes No. 10 “Tendre fleur (Tender Flower)” is given to the image recognition unit 11. A number attached above or below a musical note in the musical score is a finger number indicating a finger to be used when the musical note is played by a piano. The musical note recognition unit 12 recognizes a musical note, an accidental, a

staff, a clef, a key signature, or a time signature (hereinafter referred to as musical score elements) in the first image data recognized by the image recognition unit 11. The musical note recognition unit 12 generates first text data indicating the recognized musical score elements and coordinates of the musical score elements. FIG. 4 is a diagram showing an example of the image of musical score elements that is based on the image data generated by drawing notation fonts or lines from the first text data. As shown in FIG. 4, it is possible to generate, based on the first text data, image data in a PNG (Portable Network Graphics) format or the like indicating the image of the musical score elements.

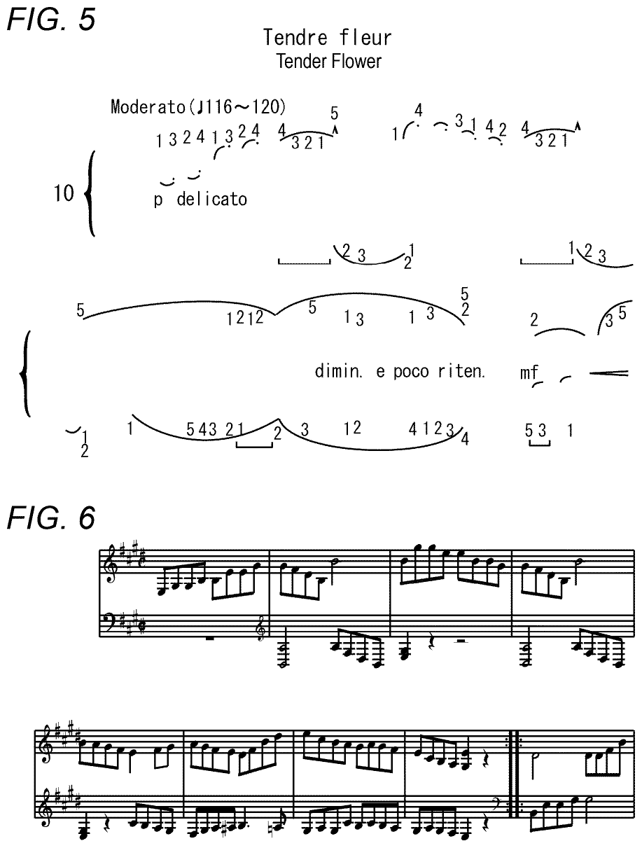

The musical note deletion unit 13 outputs second image data obtained by deleting, based on the first text data generated by the musical note recognition unit 12, the musical score elements from the first image data recognized by the image recognition unit 11. FIG. 5 is a diagram showing an example of the image of the musical score that is based on the second image data. As shown in FIG. 5, musical symbols in the second image data other than the musical note, the accidental, the staff, the clef, the key signature, and the time signature included in the first image data remain as peripheral information. The peripheral information includes, for example, a musical performance symbol, writing, explanation, and the like, and in the example of FIG. 5, corresponds to a music title and a musical performance symbol (speed, strength, an idea title, an articulation (or a stacker), a rendition style (a finger number or a pedal), and the like).

The image of the musical score of FIG. 5 can be generated as a residual difference between the image of the musical score of FIG. 3 and the image of the musical score elements of FIG. 4. That is, the image of FIG. 4 is used as a mask image for deleting the musical score elements from the image of FIG. 3, and an overlapping portion between each pixel of the image of FIG. 3 and each pixel of the image of FIG. 4 is deleted. In order to reliably delete an unnecessary portion from the image of FIG. 3, the musical note deletion unit 13 may generate the image data of FIG. 4 so as to slightly expand portions corresponding to the musical note, the accidental, the staff, the clef, the key signature, and the time signature in the image data of FIG. 4.

A method of expanding an image includes, for example, a method of using a morphology operation (expanding processing) or using a region of a bounding box (rectangle surrounding a symbol) for each symbol obtained at the time of musical score recognition as a mask image. In addition, depending on a symbol, the image may be obliquely inclined (for example, a treble clef, a note head, or dal segno), so that rotation processing may be combined in order to generate a mask image (the image of FIG. 4) with higher accuracy.

The pitch reception unit 14 receives designation of a pitch amount from the user. By operating the operation unit 150, the user can provide the pitch reception unit 14 with a pitch amount indicating a difference between a key before transposition and a key after transposition. The pitch amount may be given as the number of semitones, or may be given as the number of sharps or flats in the key signature.

Alternatively, the pitch reception unit 14 may receive designation of the key from the user. In this case, as indicated by a dotted arrow in FIG. 2, the pitch reception unit 14 detects a key before transposition from the musical notes recognized by the musical note recognition unit 12 in the musical score before transposition. Further, the pitch reception unit 14 receives the designation of the pitch amount by comparing the detected key before transposition and the designated key after transposition.

The musical note transposition unit 15 generates second text data indicating musical score elements after transposition and coordinates of the musical score elements based on the pitch amount designated by the pitch reception unit 14. In this example, the second text data is generated by rewriting the coordinates of each musical note in the first text data such that the corresponding musical note is disposed at a position moved in an upper-lower direction with respect to the staff by the designated pitch amount. Further, the musical note transposition unit 15 outputs, based on the generated second text data, third image data representing an image of the musical score elements after transposition. FIG. 6 is a diagram showing an example of the image of the musical score elements after transposition that is based on third image data.

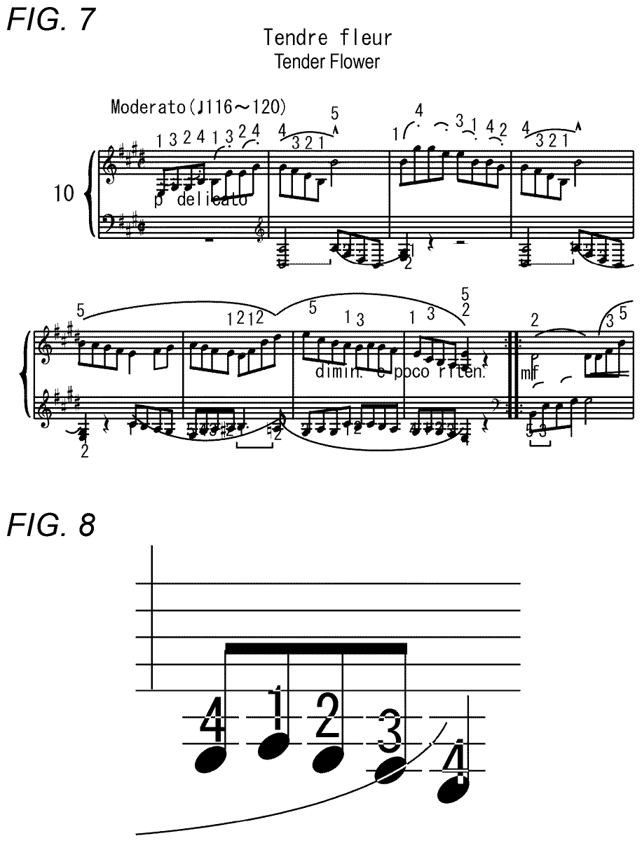

The synthesis unit 16 synthesizes the second image data (see FIG. 5) output by the musical note deletion unit 13 and the third image data (see FIG. 6) output by the musical note transposition unit 15, so as to output fourth image data indicating the musical score after transposition. FIG. 7 is a diagram showing an example of the image of the musical score after transposition that is based on the fourth image data. The synthesis unit 16 can cause the display unit 160 to display the image of the musical score after transposition based on the output fourth image data of FIG. 7.

The correction reception unit 17 receives, from the user, designation of any one of musical notes in the fourth image data output by the synthesis unit 16 and designation of a pitch amount of the designated musical note. By operating the operation unit 150, the user can designate a desired musical note and the pitch amount of the musical note in the image of the musical score after transposition displayed on the display unit 160.

When the musical note and the pitch amount are designated in the correction reception unit 17, the synthesis unit 16 corrects the coordinates of the designated musical note in the second text data based on the designated pitch amount. Accordingly, the fourth image data is updated, and the designated musical note is disposed at a position moved in the upper-lower direction by the designated pitch amount in the musical score after transposition.

### (3) Modification

In the image of the musical score after transposition, since the peripheral information and the musical score elements overlap each other, readability of the musical score may decrease. Therefore, various processing for improving the readability of the musical score may be executed.

FIG. 8 is a partially enlarged diagram showing an example of an image of a musical score after transposition in a first modification. In the first modification, the synthesis unit 16 synthesizes the second image data representing an image of the peripheral information and the third image data representing the image of the musical score elements by exclusive OR and outputs the fourth image data. According to the processing, even when the fourth image data is binary data, an overlapping portion between the peripheral information and the musical score elements is indicated in white in the image of the musical score after transposition, as shown in FIG. 8. Accordingly, the readability of the musical score is improved. When the fourth image data is not binary data, the peripheral information and the musical score elements may be displayed in different colors in the image of the musical score after transposition.

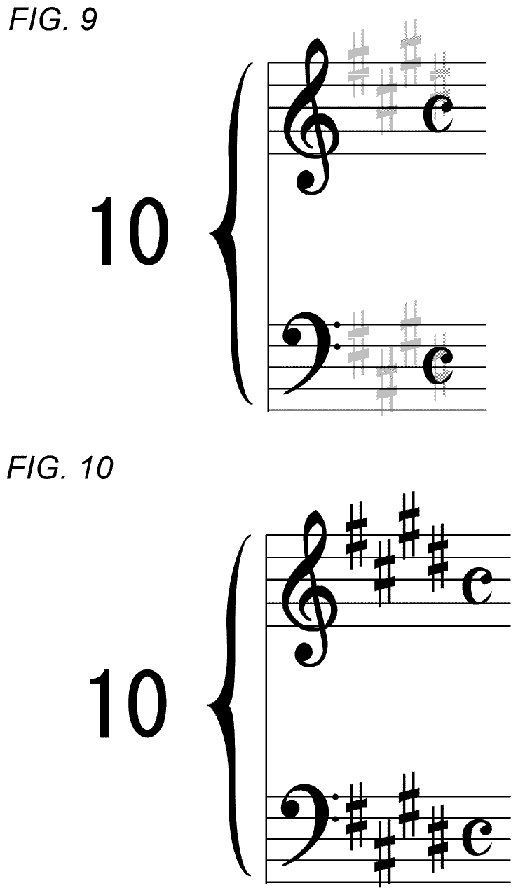

FIG. 9 is a partially enlarged diagram showing an example of an image of a musical score after transposition in a second modification. In the second modification, the musical note transposition unit 15 outputs the third image data by using different densities between: the key signature after transposition; and the clef and the time signature. According to the processing, as shown in FIG. 9, in the image of the musical score after transposition, the key signature is displayed to be lighter than the clef and the time signature. Accordingly, the readability of the musical score is improved even when the key signature overlaps the clef or the time signature. In the image of the musical score after transposition, the key signature may be displayed in a color different from that of the clef or the time signature.

FIG. 10 is a partially enlarged diagram showing an example of an image of a musical score after transposition in a third modification. In the third modification, the musical note transposition unit 15 outputs the third image data by disposing the key signature after transposition in a gap between the clef and the time signature. According to the processing, as shown in FIG. 10, the key signature is disposed so as not to overlap the clef and the time signature in the image of the musical score after transposition. Accordingly, the readability of the musical score is improved.

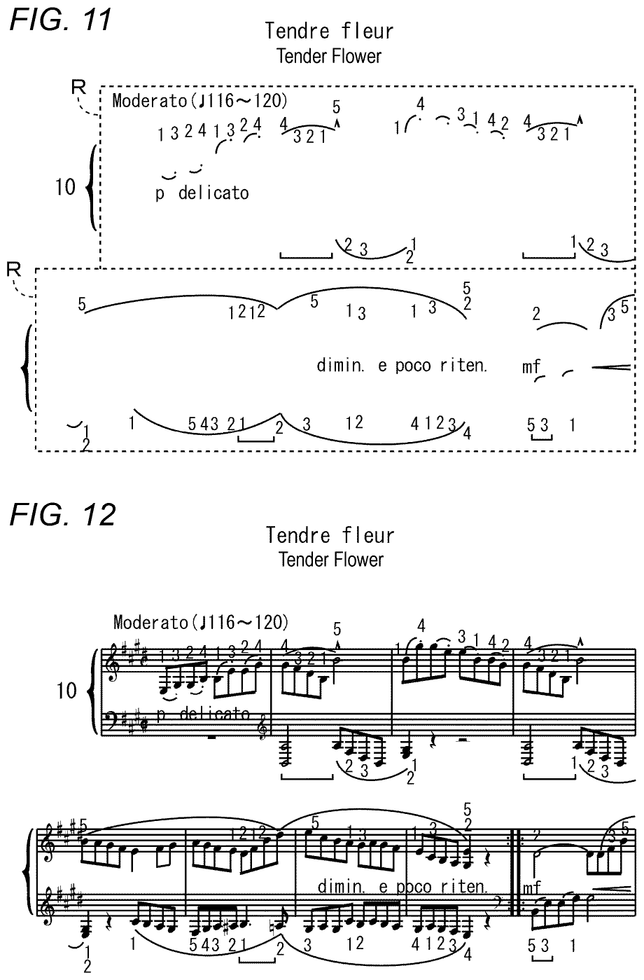

In the image of the musical score after transposition, the peripheral information corresponding to each musical note may be disposed near the corresponding musical note. FIG. 11 is a diagram illustrating a fourth modification. As indicated by a dotted line in FIG. 11, the musical note deletion unit 13 specifies a movement region R in the second image data. The movement region R is a region from a position above a region where the staff is to be disposed by a predetermined distance to a position below the region where the staff is to be disposed by a predetermined distance. A left end and a right end of the movement region R are respectively equal to a left end and a right end of the region where the staff is to be disposed.

The musical note deletion unit 13 outputs the second image data by disposing the peripheral information included in the specified movement region R among the peripheral information in the second image data at a position to follow the musical note after transposition. The synthesis unit 16 outputs the fourth image data indicating the musical score after transposition using the second image data. FIG. 12 is a diagram showing an example of the image of the musical score after transposition in the fourth modification. As shown in FIG. 12, according to the above process, the peripheral information can be disposed near the musical note in the image of the musical score after transposition.

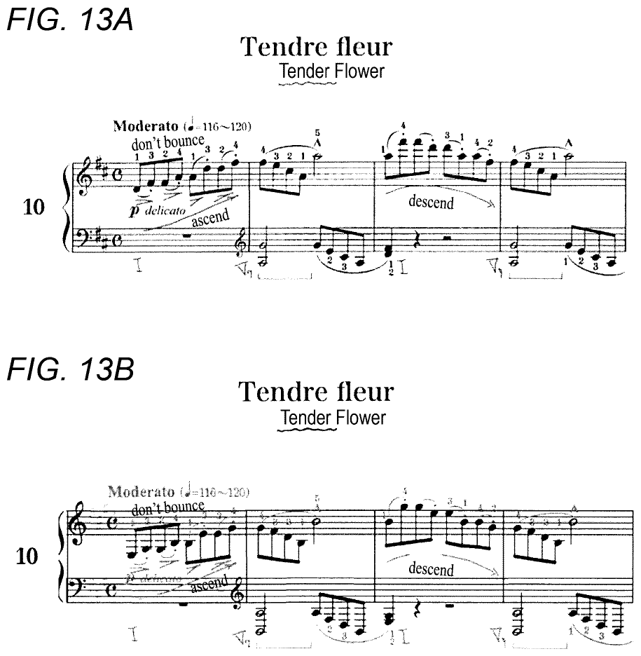

FIGS. 13A and 13B are partially enlarged diagrams showing an example of images of the musical score before and after transposition in the fourth modification. FIG. 13A shows the image of the musical score before transposition, and FIG. 13B shows the image of the musical score after transposition. As shown in FIGS. 13A and 13B, in the fourth modification, it is possible to move the musical performance symbol (such as a slur or a fingering number) or the peripheral information such as writing while maintaining a positional relationship with the musical note. Even when the second image data includes a grace note as the peripheral information due to a recognition error or the like, the grace note can be disposed at an appropriate position in the image of the musical score after transposition. In this way, even if the musical score recognition is partially wrong, the musical score is correctly transposed visually. This case is an example showing effectiveness of the present disclosure.

FIG. 14 is a partially enlarged diagram showing an example of an image of a musical score after transposition in a fifth modification. As shown in FIG. 14, the peripheral information included in the movement region R may be displayed in a color different from that of other symbols such as the musical score elements. In this case, the readability of the musical score is improved even when the peripheral information near the musical note overlaps the musical score elements. The peripheral information included in the movement region R may be displayed to be lighter than other symbols such as the musical score elements.

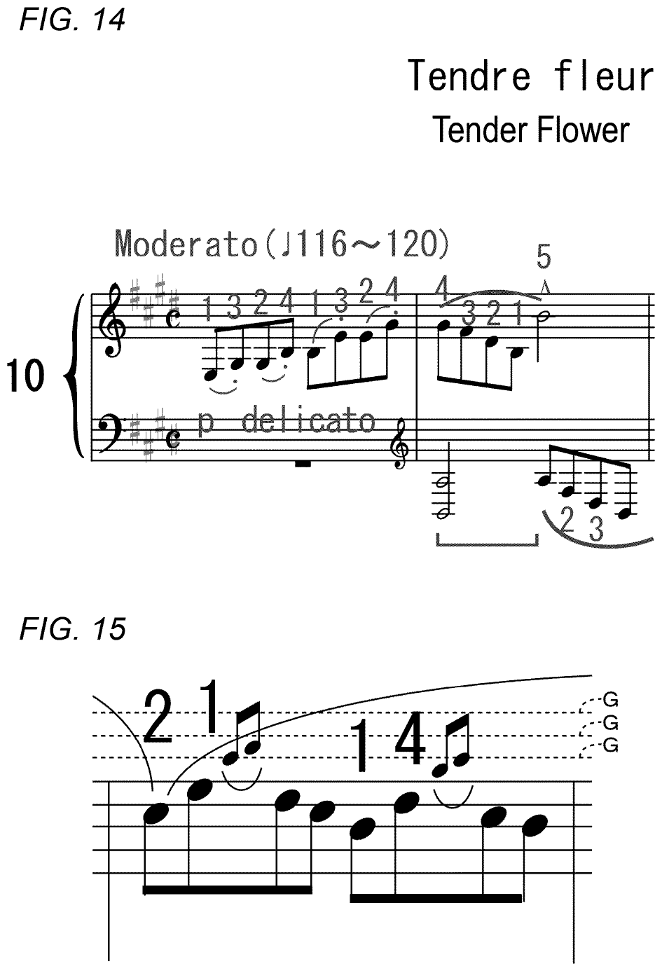

FIG. 15 is a partially enlarged diagram showing an example of an image of a musical score after transposition in a sixth modification. As shown in FIG. 15, the synthesis unit 16 may output the fourth image data by adding, above or below the staff, one or more guide straight lines G at a same distance as lines within the staff. According to the processing, the user can easily recognize a pitch of the grace note with reference to the guide straight lines G even when the grace note is disposed at a position away from the staff in a state where there is no additional line due to a musical score recognition error or the like in the transposed musical score. Accordingly, it possible to correctly recognize the pitch of the musical note even when the additional line cannot be added to the grace note due to a recognition error of the grace note or the like. Although an example for the grace note is shown here, the guide straight lines G may be used for a normal musical note.

In the example of FIG. 15, the number of guide straight lines G is three, but the embodiment is not limited thereto. The number of guide straight lines G may be freely designated by the user. In the example of FIG. 15, the guide straight line G is indicated by a dotted line, but the guide straight line G may not be indicated by a dotted line as long as the guide straight line G can be distinguished from the staff. For example, the guide straight line G may be displayed with a thickness different from that of the staff, or may be displayed with a color different from that of the staff.

### (4) Musical Score Editing Processing

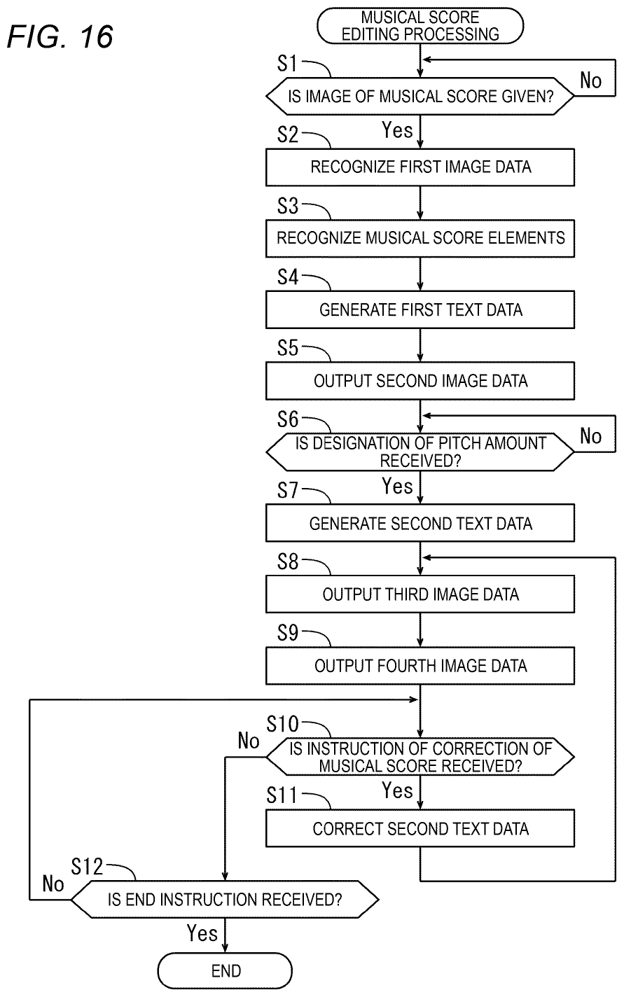

FIG. 16 is a flowchart showing an example of musical score editing processing performed by the musical score editing device 10 of FIG. 2. The musical score editing processing of FIG. 16 is performed by the CPU 130 of FIG. 1 executing the musical score editing program.

First, the image recognition unit 11 determines whether an image of a musical score is given (step S1). The user can provide the image of the musical score to the image recognition unit 11. When the image of the musical score is not given, the image recognition unit 11 waits until the image of the musical score is given. When the image of the musical score is given, the image recognition unit 11 recognizes the first image data indicating the image of the musical score given in step S1 (step S2).

Next, the musical note recognition unit 12 recognizes the musical score elements in the first image data recognized in step S2 (step S3). Further, the musical note recognition unit 12 generates the first text data indicating the musical score elements recognized in step S3 and the coordinates of the musical score elements (step S4). Subsequently, the musical note deletion unit 13 outputs the second image data obtained by deleting, based on the first text data generated in step S4, the musical score elements from the first image data recognized in step S2 (step S5).

Thereafter, the pitch reception unit 14 determines whether designation of the pitch amount indicating the difference between the key before transposition and the key after transposition is received (step S6). The user can designate the pitch amount to the pitch reception unit 14. Alternatively, the user can designate a key to the pitch reception unit 14 instead of the pitch amount. When the designation of the pitch amount is not received, the pitch reception unit 14 waits until the designation of the pitch amount is received.

When the designation of the pitch amount is received, the musical note transposition unit 15 generates, based on the pitch amount, the second text data indicating the musical score elements after transposition and the coordinates of the musical score elements (step S7). Further, the musical note transposition unit 15 outputs, based on the second text data generated in step S7, the third image data representing the image of the musical score elements after transposition (Step S8).

Next, the synthesis unit 16 synthesizes the second image data output in step S5 and the third image data output in step S8 to output the fourth image data indicating the musical score after transposition (step S9). Subsequently, the correction reception unit 17 determines whether an instruction to correct the musical score is received (step S10). The user can instruct correction of the musical score to the correction reception unit 17 by designating any one of musical notes in the fourth image data output in step S9 and the pitch amount of the designated musical note.

When the correction of the musical score is instructed, the synthesis unit 16 corrects the second text data based on the musical note and the pitch amount designated in step S10 (step S11). Specifically, in the second text data, the coordinates of the designated musical note are corrected based on the designated pitch amount. Thereafter, the synthesis unit 16 returns to step S8. Accordingly, the third image data and the fourth image data are updated, and the designated musical note is disposed at a position moved in the upper-lower direction by the designated pitch amount in the musical score after transposition.

When the instruction to correct the musical score is not received in step S10, the

synthesis unit 16 determines whether an end instruction is received (step S12). The user can instruct the synthesis unit 16 to end the musical score editing processing by performing a predetermined operation using the operation unit 150. When the end instruction is not received, the synthesis unit 16 returns to step S10. When the end instruction is received, the synthesis unit 16 ends the musical score editing processing.

### (5) Effects of Embodiment

As described above, the musical score editing device 10 according to the present embodiment includes an image recognition unit 11 configured to recognize an image of a musical score before transposition as first image data; a pitch reception unit 14 configured to receive designation of a pitch amount indicating a difference between a key before transposition and a key after transposition; a musical note recognition unit 12 configured to recognize a musical note in the first image data; a musical note deletion unit 13 configured to output second image data obtained by deleting the musical note from the first image data; a musical note transposition unit 15 configured to output third image data indicating an image of the musical note after transposition based on the pitch amount designated by the pitch reception unit 14; and a synthesis unit 16 configured to synthesize the second image data and the third image data to output fourth image data indicating an image of the musical score after transposition.

According to the configuration, a transposed musical score can be generated from an image of the musical score. Therefore, a user can generate a transposition musical score by using an image of a desired musical score, and can easily play with a transposing musical instrument, for example.

The pitch reception unit 14 may receive designation of the key after transposition, detect the key before transposition from the musical score before transposition, and receive designation of the pitch amount based on the detected key before transposition and the designated key after transposition. In this case, designation of the pitch amount from the key after transposition can be received.

The musical note recognition unit 12 may further recognize a staff in the first image data, and the musical note deletion unit 13 may output the second image data obtained by further deleting the staff from the first image data. According to the configuration, even when the image of the musical score before transposition is a staff score, the transposed musical score can be generated.

The musical note transposition unit 15 may output the third image data indicating the staff and the image of the musical note after transposition by relatively moving the recognized musical note and staff based on the pitch amount designated by the pitch reception unit 14. In this case, the transposed musical score can be easily generated.

The musical note recognition unit 12 may further recognize a clef, a key signature, and a time signature in the first image data, and the musical note deletion unit 13 may output the second image data obtained by further deleting the clef, the key signature, and the time signature from the first image data. According to the configuration, even when the image of the musical score includes the clef, the key signature, and the time signature, the transposed musical score can be generated.

The musical note deletion unit 13 outputs the second image data obtained by deleting the musical note and the like from the first image data. In a mask image (the image data of FIG. 4) for performing the deletion at this time, parts such as the musical note or the like of FIG. 4 may be expanded to be slightly larger than the musical note or the like included in the first image data. In this case, the musical note or the like can be reliably deleted from the image of the musical score indicated by the second image data.

The musical note transposition unit 15 may output the third image data by using

different densities or different colors between: the key signature after transposition; and the clef and the time signature. In this case, in the musical score after transposition, the key signature is displayed in a manner different from the clef and the time signature. Accordingly, even when the key signature overlaps the clef or the time signature, the user can easily recognize the key signature.

The musical note transposition unit 15 may output the third image data by disposing the key signature after transposition in a gap between the clef and the time signature. In this case, in the musical score after transposition, the key signature is disposed so as not to overlap the clef and the time signature. In a case where the number of symbols (sharps or flats) of the key signature is larger than the number of symbols of the key signature before transposition (the example of FIG. 10 is a case where D major (two sharps) is transposed to E major (four sharps)), since a space between the clef and the time signature is insufficient, in order to secure the space of the key signature, the third image data in which the clef and the surrounding staff are moved and extended to the left may be generated. Accordingly, the user can easily recognize the key signature.

The synthesis unit 16 may output the fourth image data by adding, above or below the staff, guide straight lines G at a same distance as lines within the staff. According to the configuration, the user can easily recognize a pitch of a grace note with reference to the guide straight lines G even when the grace note is disposed at a position away from the staff in the musical score after transposition.

The musical note deletion unit 13 may output the second image data including, as peripheral information, a performance symbol, writing, or an explanation. In this case, the peripheral information described in the image of the musical score before transposition can be maintained in the musical score after transposition.

The musical note deletion unit 13 may output the second image data by disposing the peripheral information at a position to follow the musical note after transposition. In this case, a correspondence relationship between the musical note and the peripheral information in the musical score after transposition can be easily recognized.

The musical score editing device 10 may further include a correction reception

unit 17 configured to receive designation of any one of musical notes in the fourth image data and designation of a pitch amount of the designated musical note, and the synthesis unit 16 may update the fourth image data by correcting the designated musical note based on the pitch amount designated by the correction reception unit 17. In this case, the musical note can be edited in a unit of note on the musical score after transposition.

### (6) Other Embodiments

(a) In the above embodiment, the staffs, the clefs, the key signatures, and the time signatures are included as the musical score elements in the third image data, but the embodiment is not limited thereto. A part or all of the staffs, a part or all of the clefs, a part or all of the key signatures, and a part or all of the time signatures may not be included in the third image data. In addition, a part or all of the staffs, a part or all of the clefs, a part or all of the key signatures, and a part or all of the time signatures may be included in the second image data instead of the third image data. In this case, in the image of the musical score that is based on the second image data, a part or all of the staffs, a part or all of the clefs, a part or all of the key signatures, and a part or all of the time signatures are displayed. Further, the musical note recognition unit 12 may recognize a part or all of the musical notes, a part or all of the accidentals, a part or all of the staffs, a part or all of the clefs, a part or all of the key signatures, or a part or all of the time signatures in the first image data recognized by the image recognition unit 11. The recognition target of the musical score elements in the first image data may be set by the user.

(b) In the above embodiment, the third image data is output by moving the musical note with respect to the staff, but the embodiment is not limited thereto. The third image data may be output by relatively moving the musical note and the staff. Therefore, the third image data may be output by moving the staff with respect to the musical note.

(c) In the above embodiment, the musical score editing device 10 includes the correction reception unit 17, but the embodiment is not limited thereto. When it is not necessary to edit the musical note in a unit of note in the musical score after transposition, the musical score editing device 10 may not include the correction reception unit 17.

(d) In the above embodiment, the musical note recognition unit 12 and the musical note transposition unit 15 generate text data and generate image data based on the generated text data, but the embodiment is not limited thereto. The musical note recognition unit 12 or the musical note transposition unit 15 may generate transposed image data by processing a raster image or a vector image of a musical note or the like recognized by the image recognition unit 11 or the like without generating the text data.

(e) An electronic file including an image of the musical score may be stored in the storage unit 140 or may be provided from an external device to the musical score editing device 10. In a case in which the electronic file is stored in the storage unit 140, the image recognition unit 11 may recognize the first image data indicating the image of the musical score by reading out the electronic file from the storage unit 140. The electronic file may be created by a file format including position information representing a position of each of the musical symbols, and the image recognition unit 11 may recognize the first image data using the position information contained in the electronic file.

1. A musical score editing device comprising:
a memory storing computer-executable instructions; and
a processor that implements the computer-executable instructions stored in the memory to execute a plurality of tasks, including:
an image recognition task that recognizes an image of a musical score before transposition as first image data;
a pitch reception task that receives designation of a pitch amount indicating a difference between a key before the transposition and a key after the transposition;
a musical note recognition task that recognizes one or more musical notes in the first image data;
a musical note deletion task that outputs second image data obtained by deleting the one or more musical notes from the first image data;
a musical note transposition task that outputs third image data indicating an image of one or more musical notes after the transposition based on the pitch amount designated by the pitch reception task; and
a synthesis task that synthesizes the second image data and the third image data to output fourth image data indicating an image of a musical score after the transposition.

2. The musical score editing device according to claim 1, wherein the pitch reception task further:
receives designation of the key after the transposition;
detects the key before the transposition from the musical score before the transposition; and
receives designation of the pitch amount based on the detected designated key before the transposition and the designated key after the transposition.

3. The musical score editing device according to claim 1, wherein:
the musical note recognition task further recognizes a staff in the first image data, and
the musical note deletion task outputs the second image data obtained by further deleting the staff from the first image data.

4. The musical score editing device according to claim 3, wherein the musical note transposition task outputs the third image data indicating the staff and the image of the one or more musical notes after the transposition by relatively moving the recognized one or more musical notes and the recognized staff based on the pitch amount designated by the pitch reception task.

5. The musical score editing device according to claim 3, wherein:
the musical note recognition task further recognizes a clef, a key signature, and a time signature in the first image data, and
the musical note deletion task outputs the second image data obtained by further deleting the clef, the key signature, and the time signature from the first image data.

6. The musical score editing device according to claim 5, wherein:
the musical note transposition task outputs the third image data indicating a key signature after the transposition by a first density or a first color and the clef and the time signature by a second density different from the first density or a second color different from the first color.

7. The musical score editing device according to claim 5, wherein the musical note transposition task outputs the third image data by disposing the key signature after the transposition in a gap between the clef and the time signature. 8 The musical score editing device according to claim 3, wherein the synthesis task outputs the fourth image data by adding a guide straight line, above or below the staff, at a same distance as lines within the staff.

9. The musical score editing device according to claim 1, wherein the musical note deletion task outputs the second image data comprising, as peripheral information, a musical symbol other than the one or more musical notes, an accidental, a staff, a clef, a key signature, or a time signature.

10. The musical score editing device according to claim 9, the musical note deletion task outputs the second image data by disposing the peripheral information at a position to follow the one or more musical notes after the transposition.

11. The musical score editing device according to claim 1, wherein:
the plurality of tasks further include a correction reception task that receives designation of a correction target musical note selected from the one or more musical notes in the fourth image data and designation of a correction pitch amount of the correction target musical note, and
the synthesis task updates the fourth image data by correcting the correction target musical note based on the correction pitch amount designated by the correction reception task.

12. The musical score editing device according to claim 1, wherein the musical note deletion task:
generates a mask image by applying expanding processing and rotating processing to the first image data; and
outputs the second image data by deleting the one or more musical notes included in the first image data using the mask image.

13. A musical score editing method comprising:
recognizing an image of a musical score before transposition as first image data;
receiving designation of a pitch amount indicating a difference between a key before the transposition and a key after the transposition;
recognizing one or more musical notes in the first image data;
outputting second image data obtained by deleting the one or more musical notes from the first image data;
outputting third image data indicating an image of one or more musical notes after the transposition based on the designated pitch amount; and
synthesizing the second image data and the third image data to output fourth image data indicating an image of a musical score after the transposition.

14. A non-transitory computer-readable storage medium storing a program executable by a computer to execute a musical score editing method comprising:
recognizing an image of a musical score before transposition as first image data;
receiving designation of a pitch amount indicating a difference between a key before the transposition and a key after the transposition;
recognizing one or more musical notes in the first image data;
outputting second image data obtained by deleting the one or more musical notes from the first image data;
outputting third image data indicating an image of one or more musical notes after the transposition based on the designated pitch amount; and
synthesizing the second image data and the third image data to output fourth image data indicating an image of a musical score after the transposition.
